(19) United States
(12) Patent Application Publication
(10) Pub. No.: US 2012/0194468 A1
(43) Pub. Date: Aug. 2, 2012

(54) METHOD FOR DETECTING A TOUCH POINT ON A TOUCH SENSING DEVICE AND DEVICE THEREOF

(76) Inventors: Shui-Chin Yeh, Hsinchu (TW); Kun-Tai Wu, Hsinchu (TW); Chun-Yi Wei, Hsinchu (TW)

(21) Appl. No.: 13/273,244

(22) Filed: Oct. 14, 2011

Related U.S. Application Data
(60) Provisional application No. 61/438,264, filed on Feb. 1, 2011.

(51) Int. Cl. G06F 3/044

(52) U.S. Cl. 345/174

(57) ABSTRACT

A touch sensing device includes four driving electrodes, four sensing circuits, a controller and a substrate. Each sensing circuit is coupled to one of the four driving electrodes, for sensing electrical charges of the corresponding sensing electrode. The four driving electrodes, disposed on the substrate, are electrically independent to each other. Each sensing circuit detects the electrical charges of the corresponding driving electrode, and generates a count according to the electrical charges of the corresponding driving electrode. The controller calculates a position of a touch point on the touch sensing device according to counts generated by the four sensing circuits.

### CROSS REFERENCE TO RELATED APPLICATIONS

This application claims the benefit of U.S. Provisional Application No. 61/438,264, filed on Feb. 1, 2011 and entitled “Movement Detection Based on Using Four Independent Capacitive Sensing Electrodes”, the content of which is incorporated herein by reference.

### BACKGROUND OF THE INVENTION

1. Field of the Invention

The present invention is related to a method for detecting touch points on a touch sensing device and device thereof, and more particularly, to a method for detecting touch points on a touch sensing device and device thereof according to a variation of electrical charges of four driving electrodes.

2. Description of the Prior Art

A conventional touch sensing device disposes a plurality of array sensing electrodes in corresponding x-axis and y-axis of a sensing region. The sensing electrodes of each x-axis and y-axis perform interlaced scanning periodically, for detecting any touch actions on the sensing region.

However, the sensing region has to be large enough for providing sufficient sensing resolution. In other words, the conventional touch sensing device requires a large number of sensing electrodes for providing adequate sensing resolution, so as to obtain a relatively accurate detection result. Disposing a large number of sensing electrodes increases the size and power consumption of the touch sensing device, consequently causing inconveniences.

### SUMMARY OF THE INVENTION

The present invention discloses a touch sensing device. The touch sensing device comprises a substrate, four driving electrodes, four sensing circuits and a controller. The four driving electrodes are disposed on the substrate. Each of the four sensing circuits is coupled to a driving electrode of the four driving electrodes, for detecting electrical charges of the driving electrode. The controller is for determining a position of where the touch sensing device is touched according to electrical charges detected by the four sensing circuits.

The present invention further discloses a method for detecting a touch point on a touch sensing device. The method comprises in a first duration, charging four driving electrodes ; in a second duration after the first duration, the four driving electrodes charging four sensing circuits; and in a third duration after the second duration, determining a position of the touch point according to electrical charges of the four sensing circuits.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a touch sensing device according to an embodiment of the present invention.

FIG. 2 is a diagram illustrating the sensing circuit of the touch sensing device according to an embodiment of the present invention.

FIG. 3 is a diagram illustrating a method utilizing the touch sensing device to detect touch points on the touch sensing device according to an embodiment of the present invention.

FIG. 4 is a diagram illustrating relations between the first switch, the second switch, the third switch of each sensing circuit and the output voltage.

FIG. 5 is a diagram illustrating different arrangements of the four driving electrodes.

### DETAILED DESCRIPTION

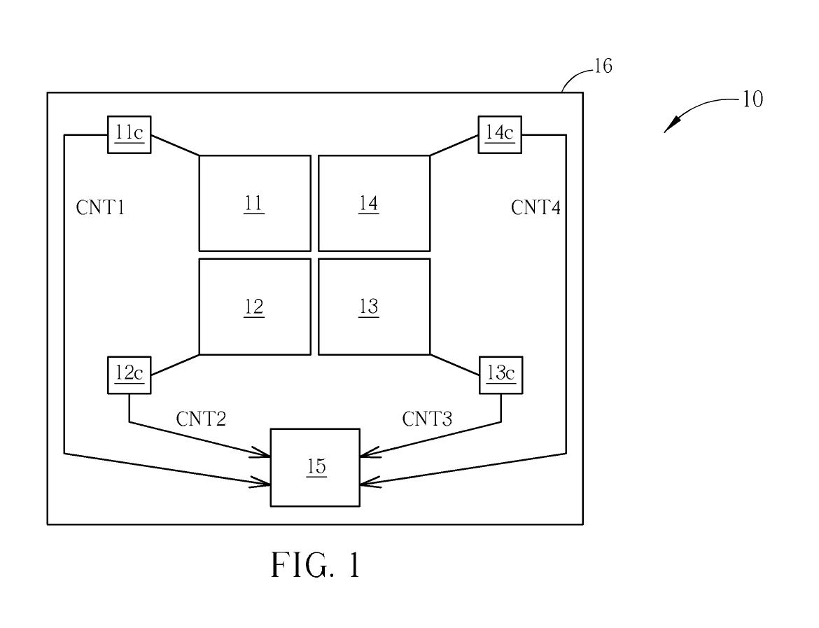

Please refer to FIG. 1. FIG. 1 is a diagram illustrating a touch sensing device 10 according to an embodiment of the present invention. The touch sensing device 10 comprises four driving electrodes 11, 12, 13 and 14, four sensing circuits 11c, 12c, 13c and 14c, a controller 15 and a substrate 16. Positions of where the four driving electrodes 11, 12, 13 and 14 are disposed correspond to a sensing region of the touch sensing device 10. Each of the four sensing circuits 11c, 12c, 13c and 14c is coupled to one of the four driving electrodes 11, 12, 13 and 14, for detecting the electrical charge of the corresponding driving electrode. For instance, the sensing circuit 11c is coupled to the driving electrode 11, the sensing circuit 12c is coupled to the driving electrode 12 and so on. The controller 15 determines the location of where the touch sensing device 10 is touched according to the electrical charges detected by the four sensing circuits 11c, 12c, 13c and 14c. The four driving electrodes 11, 12, 13 and 14 are disposed on the substrate 16 and electrically independent to each other on the substrate 16. In the present embodiment, each of the sensing circuits 11c, 12c, 13c and 14c detects the electrical charges of the corresponding driving electrodes 11, 12, 13 and 14, and generate counts CNT1, CNT2, CNT3 and CNT4 respectively according to the electrical charges of the driving electrodes 11, 12, 13 and 14. The controller 15 then calculates the position of where the touch sensing device 10 is touched according to the counts CNT1, CNT2, CNT3 and CNT4.

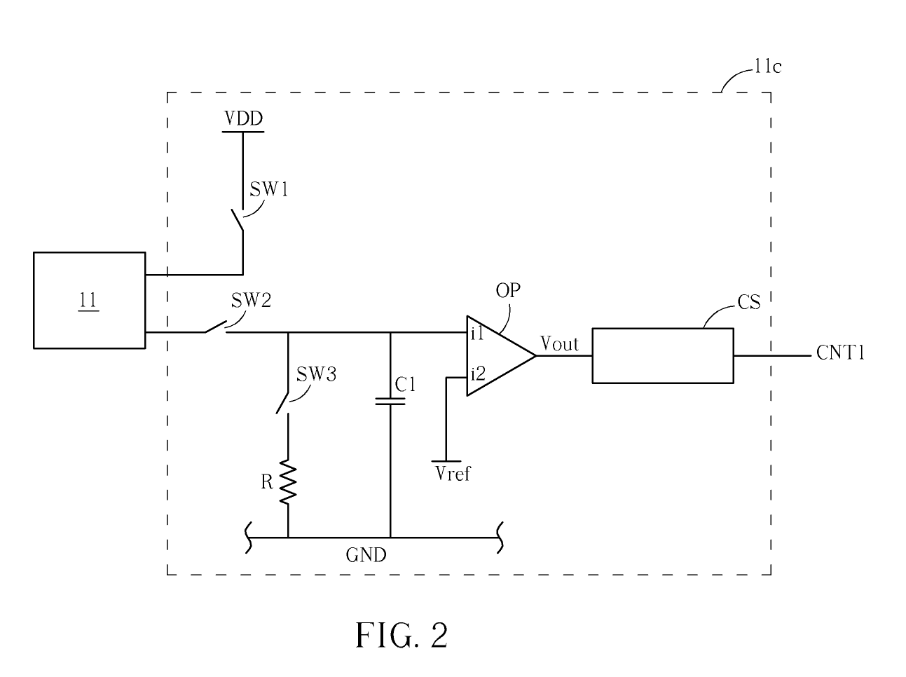

Please refer to FIG. 2. FIG. 2 is a diagram illustrating the sensing circuit 11c of the touch sensing device 10 according to an embodiment of the present invention. The sensing circuit 11c comprises a first switch SW1, a second switch SW2, a third switch SW3, a capacitor C1, an operational amplifier OP and a counter circuit CS. A first end of the first switch SW1 is coupled to a voltage source VDD, and a second end of the first switch SW1 is coupled to the driving electrode 11. A first end of the second switch SW2 is coupled to the driving electrode 11, and a second end of the second switch SW2 is coupled to a first end of the capacitor C1. A first end of the third switch SW3 is coupled to the first end of the capacitor C1, and a second end of the third switch SW3 is coupled to a resistor R. A second end of the capacitor C1 is coupled to a ground end GND. The operational amplifier OP comprises a first input end it for receiving a reference voltage Vref, a second input end i2 coupled to the first end of the capacitor C1, and an output end for outputting an output voltage Vout. The counter circuit CS is coupled to the output end of the operational amplifier OP, for receiving the output voltage Vout. In the present embodiment, the first input end it of the operational amplifier OP is a negative input end, the second input end i2 is a positive input end and a voltage level of the reference voltage Vref is half that of the voltage source VDD, but not limited to these. The counter circuit CS generates the count CNT1 according to time duration of when a voltage of the capacitor C1 varies. For instance, the output voltage Vout varies according to the voltage variation of the capacitor C1, and the counter circuit CS outputs the count CNT1 according to a variation of the output voltage Vout, for quantizing a time required to charge or discharge the capacitor C1. Structures of the sensing circuits 12c, 13c and 14c are similar to the sensing circuit 11c. The main difference is that the first ends of the first switch SW1 and the second switch SW2 of the sensing circuits 12c, 13c and 14c are coupled to the driving electrodes 12, 13 and 14 respectively.

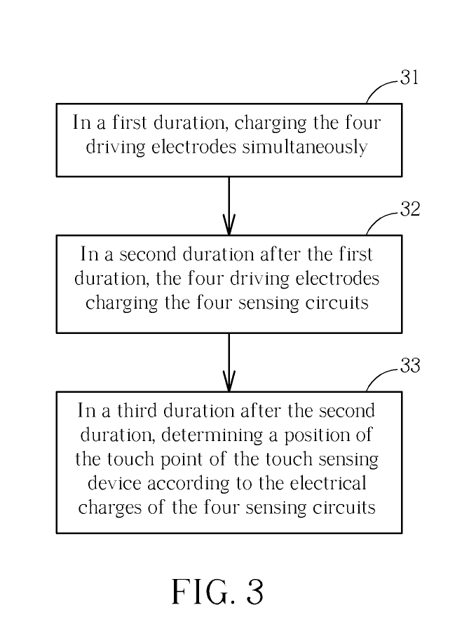

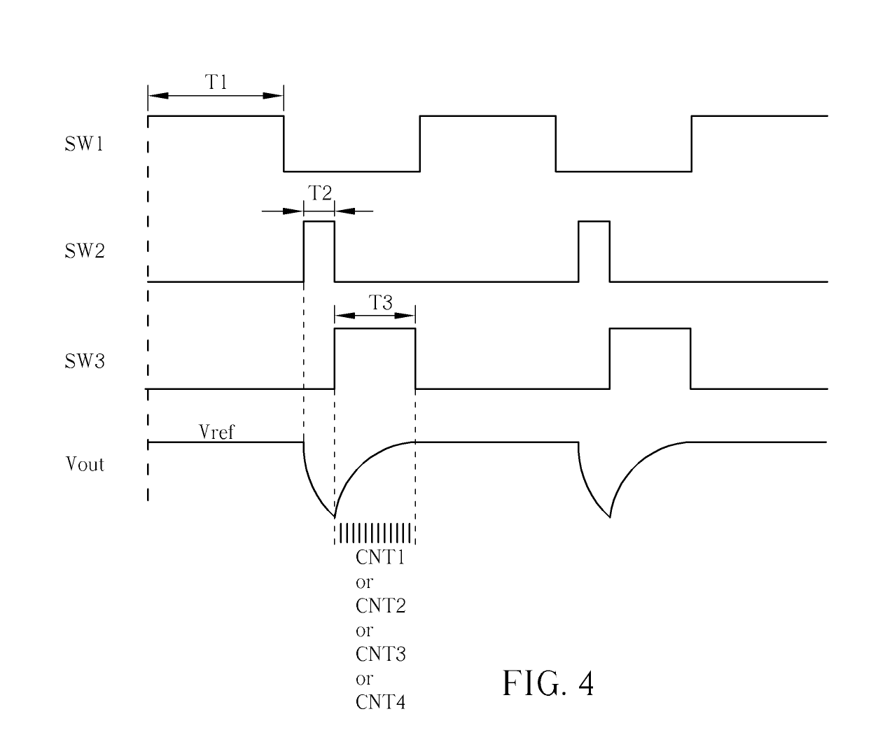

Please refer to FIG. 2, FIG. 3 and FIG. 4. FIG. 3 is a diagram illustrating a method 30 utilizing the touch sensing device 10 to detect touch points on the touch sensing device 10 according to an embodiment of the present invention. FIG. 4 is a diagram illustrating relations between the first switch SW1, the second switch SW2, the third switch SW3 of each sensing circuit 11c, 12c, 13c, 14c and the output voltage. Steps of the method 30 include:

Step 31: in a first duration T1, charging the four driving electrodes 11, 12, 13, 14 simultaneously;

Step 32: in a second duration T2 after the first duration T1, the four driving electrodes 11, 12, 13, 14 charging the four sensing circuits 11c, 12c, 13c, 14c; and

Step 33: in a third duration T3 after the second duration T2, determining a position of the touch point of the touch sensing device 10 according to the electrical charges of the four sensing circuits 11c, 12c, 13c, 14c.

Determining a position of the touch point of the touch sensing device 10 according to the electrical charges of the four sensing circuits 11c, 12c, 13c, 14c can be further specified as, for instance, determining the position of the touch point of the touch sensing device 10 according to a discharging time or a charging time of the capacitor C1 of the four sensing circuits 11c, 12c, 13c, 14c. Taking the counter circuit CS of the four sensing circuits 11c, 12c, 13c, 14c outputting respective counts CNT1, CNT2, CNT3, CNT4 according to a time required for the capacitor C1 of each sensing circuit to discharge to the voltage level of the reference voltage Vref as an example, in the first duration T1, the four sensing circuits 11c, 12c, 13c, 14c turn on the respective first switch SW1, for charging the driving electrodes 11, 12, 13, 14 to a voltage level of the voltage source VDD. In the first duration T1, the second switch SW2 and the third switch SW3 of each sensing circuit are turned off.

In the second duration T2, the four sensing circuits 11c, 12c, 13c, 14c simultaneously turn off the respective first switch SW1 and turn on the respective second switch SW2, for transmitting the electrical charges of the driving electrodes 11, 12, 13, 14 to the capacitor C1 of each of the four sensing circuits 11c, 12c, 13c, 14c respectively. In the second duration, the first switch SW1 and the third switch SW3 of each sensing circuit are turned off. In the third duration T3, the four sensing circuits 11c, 12c, 13c, 14c simultaneously turn off the respective second switch SW2 and turn on the respective third switch SW3, for the capacitor C1 of each sensing circuit to discharge via the resistor R. In the third duration T3, the first switch SW1 and the second switch SW2 of each sensing circuit are turned off.

In the present embodiment, the first input end it of the operational amplifier OP of the capacitor C1 is a negative input end, and the second input end i2 receiving the reference voltage Vref is a positive input end. In the first duration T1, the second switch SW2 of each sensing circuit is turned off, so the operational amplifier OP of each sensing circuit outputs the output voltage Vout that equals the reference voltage Vref. In the second duration T2, the second switch SW2 of each sensing circuit is turned on. When the electrical charges of the driving electrodes 11, 12, 13, 14 are transmitted to the four sensing circuits 11c, 12c, 13c, 14c respectively for charging the corresponding capacitor C1, the output voltage Vout of each of the four sensing circuits 11c, 12c, 13c, 14c is instantly pulled to a voltage level that is lower than the reference voltage Vref. In the third duration T3, the third switch SW3 of each sensing circuit is turned on, and the respective capacitor C1 gradually discharges via the corresponding resistor R, for the output voltage Vout of each of the four sensing circuits 11c, 12c, 13c, 14c to gradually pull back to the voltage level of the reference voltage Vref. The counter circuit CS of each of the four sensing circuits 11c, 12c, 13c, 14c outputs counts CNT1, CNT2, CNT3, CNT4 respectively according to the discharge time (e.g. time required for voltage level of the output voltage Vout to pull back to that of the reference voltage Vref) of the capacitor C1 of each respective sensing circuit in the third duration T3

When the driving electrode 11, 12, 13 or 14 is touched by a finger or a conductive object, the driving electrode 11, 12, 13 or 14 is equivalently connected in parallel to the touching object, for increasing capacitance of the driving electrode being touched. Therefore, assume the voltage level of the voltage source VDD is constant, when the driving electrode 11, 12, 13 or 14 is touched in the first duration T1, the electrical charges of the driving electrode being touched are increased accordingly. In other words, the driving electrode being touched can transmit more electrical charges to the corresponding capacitor C1 in the second duration T2 when compared to the driving electrode without being touched, for the capacitor C1 corresponding to the driving electrode being touched requires a longer time to discharge to the voltage level of the reference voltage Vref, and consequently the counter circuit CS corresponding to the driving electrode being touched generates a relatively larger count.

The capacitance variation (e.g. corresponds to the electrical charge variation) of the driving electrodes 11, 12, 13 or 14 is directly proportional to an area of the touching object contacting the driving electrodes 11, 12, 13 or 14. This way, when the sensing region formed by the driving electrodes 11, 12, 13 and 14 is touched, the counter circuit CS of each sensing circuit 11c, 12c, 13c and 14c outputs count CNT1, CNT2, CNT3 and CNT4 respectively of corresponding magnitudes, according a degree of each driving electrodes 11, 12, 13 and 14 being touched.

The counter circuit CS of each sensing circuit 11c, 12c, 13c and 14c outputs the respective count CNT1, CNT2, CNT3 and CNT4 according to the time required for the capacitor C1 to discharge to the voltage level of the reference voltage Vref is only an exemplifying embodiment. Those skilled in the art can make modifications according to practical demands. For instance, the counter circuit CS of each sensing circuit 11c, 12c, 13c and 14c can also output count CNT1, CNT2, CNT3 and CNT4 respectively according a time for the capacitor C1 of each sensing circuit to charge to the voltage level of the reference voltage Vref.

A core principle of the present invention is to quantizing the electrical charges of the four driving electrodes 11, 12, 13 and 14 to quantized data such as counts CNT1, CNT2, CNT3 and CNT4 by detecting the electrical charge variation of the driving electrodes 11, 12, 13 and 14. This way, the touch sensing device 10 can obtain the position being touched according to counts CNT1, CNT2, CNT3 and CNT4. If only two driving electrodes are utilized, two counts are obtained and only touch positions on the x-axis or the y-axis can be calculated. Therefore, the present invention utilizes four driving electrodes 11, 12, 13 and 14, which are electrically independent on the substrate 16, for calculating touch points on the x-axis and y-axis. Taking the four driving electrodes 11, 12, 13 and 14 of the touch sensing device 10 in FIG. 1 as an example, the position of the touch point on the x-axis and the y-axis can be calculated according to the following formulae:

Position of the touch point on the x-axis:

[(CNT3+CNT4)−(CNT1+CNT2)]/(CNT1+CNT2+CNT3+CNT4)

Position of the touch point on the y-axis:

[(CNT2+CNT3)−(CNT1+CNT4)]/(CNT1+CNT2+CNT3+CNT4)

The position of the touch point on the x-axis and the y-axis obtained from the above calculation is between the range of integers “−1” and “1”. If the position of the touch point on the x-axis and the y-axis obtained from the above calculation is multiplied by a parameter such as a resolution of a display device, the position of the touch point on the display device can be obtained. This way, the touch sensing device 10 can also be applied to an input device such as a computer mouse.

Since the four sensing circuits 11c, 12c, 13c and 14c perform the same action to the respective first switch SW1, the second switch SW2 and the third switch SW3 simultaneously, the touch sensing device 10 charges the driving electrodes 11, 12, 13 and 14 simultaneously and detects the electrical charge variation of the capacitor C1 of each sensing circuit simultaneously. This way, the touch sensing device 10 does not require performing interlaced scanning to each driving electrode periodically, and the detection response time can be reduced.

In another embodiment of the present invention, the touch sensing device 10 can also detect touch actions/gestures performed on the touch sensing device 10 according to counts CNT1, CNT2, CNT3 and CNT4. For instance, touch actions/gestures performed on the touch sensing device 10 can be a finger or a conductive object sliding across the touch sensing device 10. When the finger of a user touches a first position P1 on the sensing region formed by the four driving electrodes 11, 12, 13 and 14, the capacitance of the four driving electrodes 11, 12, 13 and 14 varies and counts CNT1, CNT2, CNT3 and CNT4 are generated accordingly for generating a position ratio of the first position P1. When the finger of the user slides from the first position P1 to a second position P2 on the sensing region formed by the four driving electrodes 11, 12, 13 and 14, the capacitance of the four driving electrodes 11, 12, 13 and 14 varies and counts CNT1, CNT2, CNT3 and CNT4 are generated accordingly for generating a position ratio of the second position P2. When the finger of the user slides across the touch sensing device 10, the capacitance of the four driving electrodes 11, 12, 13 and 14 varies accordingly. Since the trail of the sliding action can be represented by a plurality of touch points, the four driving electrodes 11, 12, 13 and 14 generate counts CNT1, CNT2, CNT3 and CNT4 corresponding to the plurality of touch points, for generating positions of the plurality of touch points. This way, the touch sensing device 10 can determine trails of sliding actions performed on the touch sensing device 10 according to positions of the plurality of touch points.

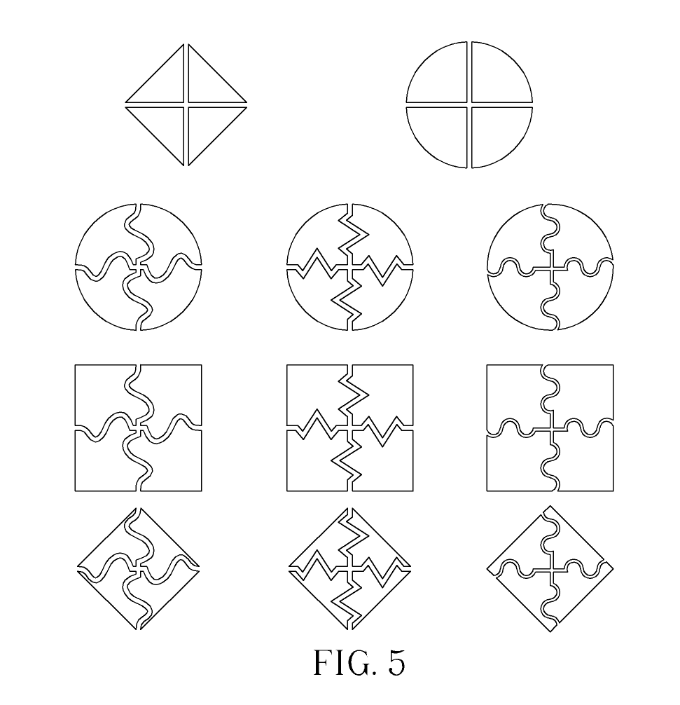

The four driving electrodes 11, 12, 13 and 14 are arranged in a two by two matrix. The four driving electrodes 11, 12, 13 and 14 are not limited to be arranged in the way as shown in FIG. 1. The four driving electrodes 11, 12, 13 and 14 can be designed to be two by two matrices of different shapes, arrangements or sizes according to practical demands. For instance, the four driving electrodes 11, 12, 13 and 14 can be arranged in two by two matrices of different shapes, arrangements or sizes according to sensing resolution required or detection speed of each driving electrode. Please refer to FIG. 5. FIG. 5 is a diagram illustrating different arrangements of the four driving electrodes 11, 12, 13 and 14. No matter the four driving electrodes 11, 12, 13 and 14 are arranged in a two by two matrix of which shape, arrangement or size, the four driving electrodes 11, 12, 13 and 14 must be arranged as electrically independent to each other (e.g. electrically independent to each other on the substrate 16). If the four driving electrodes 11, 12, 13 and 14 are not arranged as electrically independent to each other on the substrate 16, the capacitance or electrical charges of each driving electrode may affect other driving electrodes, and a degree of each driving electrode being touched cannot be determined. Further, although the present invention does not limit distance between each of the four driving electrodes 11, 12, 13 and 14, the distance between each of the four driving electrodes 11, 12, 13 and 14 must allow the four driving electrodes 11, 12, 13 and 14 to detect touch actions, for each driving electrode to generate electrical charge variation.

In conclusion, the touch sensing device of the present invention simultaneously detects the electrical charges of the four driving electrodes and quantizing the electrical charges of each driving electrode into counts. The touch sensing device can then generates the position ratio of the touch point on the x-axis and y-axis of the sensing region formed by the four driving electrodes according to the quantized counts. This way, the touch sensing device of the present invention only requires four driving electrodes and four corresponding sensing circuits to calculate the position ratio of the touch point, significantly reducing the sensing electrodes required and further reducing the size and power consumption of the touch sensing device.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A touch sensing device, comprising:
a substrate;
four driving electrodes, disposed on the substrate;
four sensing circuits, wherein each sensing circuit is coupled to a driving electrode of the four driving electrodes, for detecting electrical charges of the driving electrode; and
a controller, for determining a position of where the touch sensing device is touched according to electrical charges detected by the four sensing circuits.

2. The touch sensing device of claim 1, wherein the sensing circuit comprises:
a capacitor, comprising a first end, and a second end coupled to a ground end;
a first switch, comprising a first end coupled to a voltage source, and a second end coupled to the driving electrode;
a second switch, comprising a first end coupled to the driving electrode, and a second end coupled to the first end of the capacitor;
a third switch, comprising a first end coupled to the first end of the capacitor, and a second end coupled to a resistor;
an operational amplifier, comprising a first input end for receiving a reference voltage, a second input end coupled to the first end of the capacitor, and an output end; and
a counter circuit, coupled to the output end of the operational amplifier, for calculating a time required for discharging the capacitor to a voltage level of the reference voltage.

3. The touch sensing device of claim 2, wherein the voltage level of the reference voltage is half a voltage level of the voltage source.

4. The touch sensing device of claim 1, wherein the four driving electrodes are arranged in a two by two matrix.

5. The touch sensing device of claim 1, wherein the four driving electrodes are electrically independent on the substrate.

6. A method for detecting a touch point on a touch sensing device, comprising:
in a first duration, charging four driving electrodes;
in a second duration after the first duration, the four driving electrodes charging four sensing circuits; and
in a third duration after the second duration, determining a position of the touch point according to electrical charges of the four sensing circuits.

7. The method of claim 6, wherein determining the position of the touch point according to the electrical charges of the four sensing circuits is determining the position of the touch point according to a time to charge a capacitor of each of the four sensing circuits.

8. The method of claim 6, wherein determining the position of the touch point according to the electrical charges of the four sensing circuits is determining the position of the touch point according to a time to discharge a capacitor of each of the four sensing circuits.

9. The method of claim 6, wherein charging the four driving electrodes is charging the four driving electrodes simultaneously, and the four driving electrodes charging the four sensing circuits is the four driving electrodes charging the four sensing circuits simultaneously.

10. The method of claim 6, wherein the four driving electrodes charging the four sensing circuits is the four driving electrodes charging a capacitor of each of the four sensing circuits respectively.
